(19) United States
(12) Patent Application Publication
(10) Pub. No.: US 2025/0378218 A1
(43) Pub. Date: Dec. 11, 2025

(54) SYSTEMATIC TOLERANCE ASCERTAINMENT FOR SAMPLES OF A SERIES PRODUCT

(71) Applicant: Robert Bosch GmbH, Stuttgart (DE)

(72) Inventors: Philip Lucas Neureuther, Neckarwestheim (DE); Stefan Gruener, Auenwald (DE); Kim Peter Wabersich, Schwaebisch Gmuend (DE); Mark Philipp Riek, Abtsgmuend (DE)

(21) Appl. No.: 19/185,368

(22) Filed: Apr. 22, 2025

(30) Foreign Application Priority Data
Apr. 29, 2024 (DE) 10 2024 204 003.7

(51) Int. Cl. G06F 30/15

(52) U.S. Cl. CPC G06F 30/15

(57) ABSTRACT

A computer-implemented method for ascertaining a tolerance zone in an operational design domain (ODD) around a target parameter sample of a parameterizable simulation model for a product, in particular a steer-by-wire steering system and/or a steering system for highly automated driving. The method includes: calculating a dissimilarity metric based on each pair of a plurality of pairs, wherein each pair comprises a parameterized simulation model associated with the target parameter sample and a parameterized simulation model of a plurality of parameterized simulation models, wherein each pair yields a distance, thereby resulting in a plurality of distances; optionally wherein the dissimilarity metric is based on a gap metric, a ν-gap metric and/or an L2 metric; and determining the tolerance zone in the ODD around the target parameter sample based on the plurality of distances and on a maximum tolerable distance.

### BACKGROUND INFORMATION

Series products (in particular large-scale series products) such as steering systems are subject to a variation in product parameters such as friction, elasticity and/or inertia due to manufacturing tolerances and manufacturing inaccuracies. Furthermore, series products are subject to additional parameter variation due to aging, e.g., due to wear and/or environmental influences. All value ranges and value combinations of the parameter variation of a series product that occur in reality form its so-called “operational design domain” (ODD).

In every simulation model of a (series) product, deviations occur between modeled and real behavior due to the parameter variation throughout the ODD and due to simplifications in modeling. Such a simulation model, including the model deviations and/or model uncertainties throughout the ODD, is the basis for a simulation-based product approval. The characterization of model uncertainties required for this is currently typically carried out using a few selected product prototypes, since complete characterization is usually too complex. In the following, the target version (also: ideal version) of a prototype is referred to as a product sample and its physical realization as a product specimen. Typically, the selection of product samples for uncertainty characterization is based on expert opinion.

However, an exact realization of the selected (ideal) product samples is not possible in practice due to finite manufacturing accuracies, which means that the product samples and the associated product specimens have slightly different system behaviors. Typically, the acceptable parameter tolerances for the realization of a product sample are defined by expert knowledge. Alternatively, the aim can be to manufacture and/or rework the product specimens as accurately as possible. However, this does not rule out the possibility that parameter tolerances that are too lax are defined and/or produced, which can lead to significant deviations in system behavior between product samples and product specimens. On the other hand, it cannot be ruled out that parameter tolerances that are too strict are defined and/or produced, which can result in the system behavior of product samples and product specimens being practically identical, although this can result in unnecessarily high production costs.

A problem to be solved according to the present invention includes, for example, providing a method for ascertaining how much product specimens can deviate from a given product sample in order to still sufficiently realize this product sample with regard to its system behavior.

Compared to traditional steering systems, steer-by-wire (SbW) steering systems and/or steering systems for highly automated driving (HAD) are subject to stricter normative requirements for product approval. To ensure that the real-world testing and trial effort does not increase significantly compared to traditional steering systems due to the stricter approval requirements for SbW and HAD steering systems produced in (large-scale) series, the industry is focusing on simulation- based approval processes. For such a simulation-based approval, a validated and verified simulation model of the steering system with known model uncertainties is essential.

As part of the company's internal and simulation-based approval process for SbW and/or HAD steering systems, the model uncertainties will be characterized using a few selected product specimens.

An upstream problem to be solved can therefore be to systematically select the corresponding product samples using a model-based criterion so that they represent the entire ODD of the (large-scale) series steering system with a quantifiable residual uncertainty.

Currently, there is no systematic procedure to ascertain meaningful parameter tolerances for the realization of product samples, so that a negligible quantitative system behavior dissimilarity between product samples and product specimens can be ensured and thus excessively strict or lax tolerances can be avoided.

In systems theory, various metrics are available that quantify the dissimilarity of two systems-systems and products can subsequently be equated-and thus compare them. The gap metric, ν-gap metric and L2 metric are explained below.

The gap metric quantifies the dissimilarity of the uncontrolled (open-loop) input/output behavior of two systems P1 and P2 with respect to their stability and performance characteristics in controlled operation (closed-loop) with a scalar in the real interval [0, 1]. A metric result close to 0 means that both systems are very similar and each P1-stabilizing controller also stabilizes the P2 system with a similar controlled performance. A metric result of 0 means that the considered systems P1 and P2 behave exactly identically. On the other hand, a metric result close to or at 1 indicates that systems P1 and P2 are very dissimilar. Furthermore, the gap metric allows statements to be made about the robust stability of closed control loops with model uncertainties. An explicit controller design is necessary for the evaluation of the gap metric. Details on the definition and properties of the gap metric are described in Chapter 17 of the book “Essentials of Robust Control,” Kemin Zhou and John C. Doyle, 1st edition, Pearson, 1997, ISBN: 9780135258332.

The system-theoretical statements and implications of the ν-gap metric are very similar to the gap metric, but both metrics are defined fundamentally differently. For the evaluation of the ν-gap metric, no controller design is necessary but a turns number analysis of the systems P1 and P2 to be compared is necessary. Details on the definition and properties of the ν-gap metric are described in Chapter 17 of the book “Essentials of Robust Control,” Kemin Zhou and John C. Doyle, 1st edition, Pearson, 1997, ISBN: 9780135258332 or in the paper “Frequency domain uncertainty and the graph topology,” Glenn Vinnicombe, IEEE Transactions on Automatic Control, vol. 38, no. 9, pp. 1371-1383 September 1993, DOI: 10.1109/9.237648.

The definition of the L2 metric corresponds to the v-gap metric without turns number analysis. For this reason, the principal statements and implications of both metrics are similar, but the L2 metric has less theoretical power. Details on the definition and properties of the L2 metric are described in Chapter 17 of the book “Essentials of Robust Control,” Kemin Zhou and John C. Doyle, 1st edition, Pearson, 1997, ISBN: 9780135258332.

All three dissimilarity metrics presented are known to have the following properties:
The metrics quantify the dissimilarity of two systems with regard to stability and performance characteristics in controlled operation based on the uncontrolled input/output behavior.
The metric results can be used to decide whether two systems P1 and P2 are sufficiently similar so that P1 can be considered representative of P2.
The metric results can also be interpreted as (system-theoretical) distances between the compared systems.
For all systems to be compared: L2 result≤ν-gap result≤gap result.

### SUMMARY

A first general aspect of the present invention relates to a computer-implemented method for ascertaining a tolerance zone in an operational design domain (ODD) around a target parameter sample of a parameterizable simulation model for a product. The product can, for example, be a steer-by-wire steering system and/or a steering system for highly automated driving.

According to an example embodiment of the present invention, the method includes calculating a dissimilarity metric based on each pair of a plurality of pairs, wherein each pair comprises a parameterized simulation model associated with the target parameter sample and a parameterized simulation model of a plurality of parameterized simulation models, wherein each pair yields a distance, thereby resulting in a plurality of distances. The dissimilarity metric can be based, for example, on a gap metric, a ν-gap metric and/or an L2 metric.

According to an example embodiment of the present invention, the method further comprises determining the tolerance zone in the ODD around the target parameter sample based on the plurality of distances and on a maximum tolerable distance.

A second general aspect of the present invention relates to a computer system designed to carry out the computer-implemented method for ascertaining a tolerance zone in an operational design domain (ODD) around a target parameter sample of a parameterizable simulation model for a product according to the first general aspect (or an embodiment thereof) of the present invention.

A third general aspect of the present invention relates to a computer program designed to carry out the computer-implemented method according to the present invention for ascertaining a tolerance zone in an operational design domain (ODD) around a target parameter sample of a parameterizable simulation model for a product according to the first general aspect (or an embodiment thereof).

A fourth general aspect of the present invention relates to a computer-readable medium or signal that stores and/or contains the computer program according to the third general aspect (or an embodiment thereof) of the present invention.

By means of the method provided herin according to the first general aspect (or an embodiment thereof) of the present invention, tolerance zones can be systematically ascertained individually for the realization (i.e., physical production) of product samples based on a model-based criterion, so that the system behaviors of product samples and product specimens each correspond up to a tolerable quantitative dissimilarity. In particular, parameter tolerances for the product samples can be ascertained. The product sample to be produced is associated with the target parameter sample, i.e., the target version (also: ideal version) of a prototype. In the realization of the product sample, a product specimen can be built as a prototype in such a way that its parameter sample lies in the tolerance zone around the target parameter sample.

In particular, the following advantages compared to the related art can be achieved by the method according to the present invention disclosed herein according to the first general aspect (or an embodiment thereof):
systematic procedure for ascertaining individual parameter tolerances (i.e., permissible value range of one or more parameters) for the realization of the product samples;
calculable individual tolerance zones of the product parameters (i.e., allowed range for all parameters) for all product samples;
quantifiable system behavior dissimilarities between product samples and product specimens due to mismatched parameters throughout the ODD;
possibility of searching for local product parameters or product combinations in the vicinity of a product sample that have a particularly strong influence on its system behavior.

The method provided according to the first general aspect (or an embodiment thereof) of the present invention can be used in the development of real (i.e., physical) products—e.g., steer-by-wire (SbW) steering systems—in the design phase and/or in system development (i.e., after the design phase).

In, for example, the design phase or system development, the present invention can be used to ascertain individual tolerance zones of the (product) parameters for the realization of all product samples (e.g., for the characterization of model uncertainties) while maintaining a tolerable system behavior dissimilarity between product samples and product specimens. In particular, individual parameter tolerances can be calculated for all product samples to be realized, in which parameter tolerances the tolerable system behavior dissimilarity is maintained. This is important because prototypes of which the parameters exactly match the target parameter samples are difficult to produce or can only be produced and/or retrofitted (e. g., shimming) with considerable effort.

In addition, for example, in the design phase using intermediate results of the method according to the first general aspect (or an embodiment thereof) of the present invention and additional mathematical investigations, local product parameters and/or their combinations in the vicinity of a product sample can be found that have a particularly strong influence on its system behavior.

According to an example embodiment of the present invention, the target parameter sample can be one of a plurality of representative parameter samples in the ODD, i.e., a plurality of parameter samples that represent the entire ODD of the (series) product with a quantifiable residual uncertainty. The realized product sample (more precisely: the product specimen) is then a representative product specimen. On the other hand, the target parameter sample does not have to be a representative parameter sample, i.e., it can be specified arbitrarily or for other reasons (e.g., as a boundary sample) as the target for the realization.

Based on the representative product specimens, the uncertainties caused by parameter variation and simplifications in the modeling between the real product behavior and its modeled behavior can be systematically characterized throughout the ODD in further system development. The representative product specimens including the characterized model uncertainties can then be used for the development of a product control system and/or for product approval.

The example method provided according to the first general aspect (or an embodiment thereof) of the present invention can be applied in particular in the context of a process for the approval of SbW and HAD steering systems. The realization of product samples representative of the entire ODD can be used in the validation and/or verification of the steering systems.

The example method provided according to the first general aspect (or an embodiment thereof) of the present invention can be carried out wholly or partially numerically. This is advantageous because it does not depend on the parameterizable simulation model being in an analytical form.

### BRIEF DESCRIPTION OF THE DRAWINGS

FIG. 1 schematically illustrates exemplary embodiments of a computer-implemented method of the present invention for ascertaining a tolerance zone in an operational design domain (ODD) around a target parameter sample of a parameterizable simulation model for a product, in particular a steer-by-wire steering system and/or a steering system for highly automated driving.

FIG. 2A schematically illustrates an example embodiment of the present invention for determining the tolerance zone in the ODD based on selected parameterized simulation models of which the particular distance to the parameterized simulation model associated with the target parameter sample sufficiently corresponds to the maximum tolerable distance.

FIG. 2B schematically illustrates an example embodiment of the present invention for determining the tolerance zone in the ODD based on interpolating the distances to the parameterized simulation model associated with the target parameter sample, resulting in a distance map in the ODD.

FIG. 3 illustrates an exemplary embodiment of the method of the present invention.

FIG. 4A illustrates an exemplary ODD with a plurality of parameterized simulation models, a target parameter sample surrounded by a tolerance zone, according to the present invention.

FIG. 4B illustrates the exemplary ODD from FIG. 4A without the plurality of parameterized simulation models, according to the present invention.

### DETAILED DESCRIPTION OF EXAMPLE EMBODIMENTS

The aim of the method 100 proposed in this disclosure is to ascertain a tolerance zone 30 in an operational design domain (ODD) around a target parameter sample 10 of a parameterizable simulation model for a product, in particular a steer-by-wire steering system and/or a steering system for highly automated driving. Alternatively or additionally, the aim of the method 100 can also be to produce a product sample in the form of a product specimen that the product sample realizes.

The method 100 is wholly or partly numerical and can therefore be applied even if the parameterizable simulation model is not in an analytical form.

First, a computer-implemented method 100 for ascertaining a tolerance zone 30 in an operational design domain (ODD) around a target parameter sample 10 of a parameterizable simulation model for a product is disclosed. In particular, the product can be a serial product, i.e., produced in series. The method 100—although it can also be applied to a non-series product or a small series—is particularly useful when a plurality of similar products are to be produced, but which may nevertheless be different (e.g., for production and/or material reasons). The plurality of similar products can, for example, comprise >1 e5products per year, >5 e5 products per year or >1 e6 products per year.

The product can, for example, be a steer-by-wire steering system. Alternatively or additionally, the product can be a steering system for automated, particularly highly automated, driving.

The parameterizable simulation model can, but need not, be analytical.

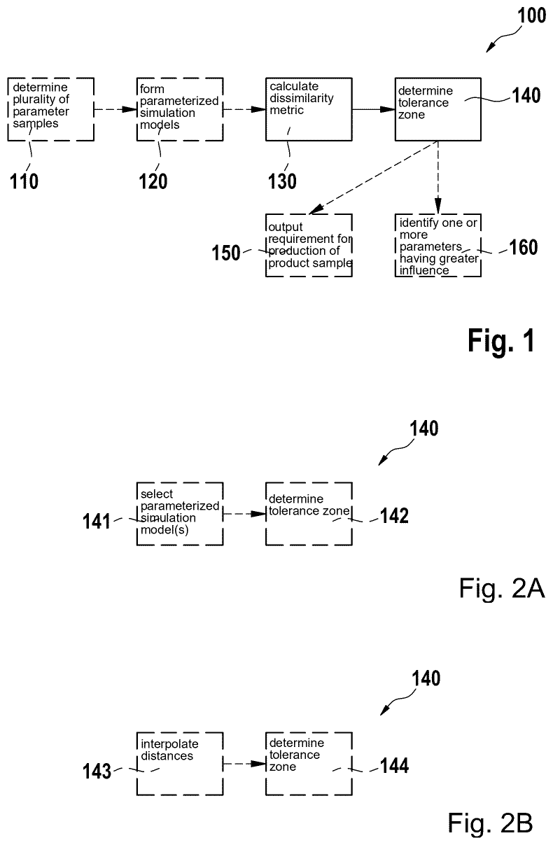

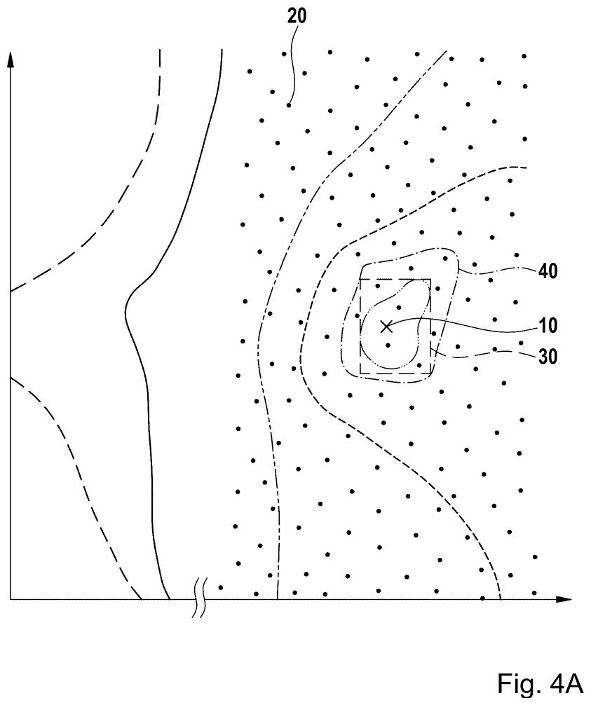

As schematically illustrated, for example, in FIG. 1, the method 100 comprises calculating 130 a dissimilarity metric based on each pair of a plurality of pairs, wherein each pair comprises a parameterized simulation model associated with the target parameter sample 10 (always the same for this plurality of pairs, referred to in FIG. 3 as a sample PUM) and a parameterized simulation model of a plurality of parameterized simulation models, wherein each pair yields a distance, thereby resulting in a plurality of distances. In the exemplary embodiment in FIG. 3, step 130 is referred to as “calculating the dissimilarities between all PUMs and sample PUMS.”

The dissimilarity metric can be based on a gap metric, a ν-gap metric and/or an L2 metric. In particular, the dissimilarity metric can be the gap metric, the ν-gap metric or the L2 metric. Alternatively, the dissimilarity metric can be based on a combination of the gap metric, the ν-gap metric and/or the L2 metric. The dissimilarity metric can output a quantitative measure of the dissimilarity of a pair of parameterized simulation models, i.e., a quantitative measure of how similar or dissimilar the two parameterized simulation models of the pair are. In this respect, the dissimilarity metric could also be called a similarity metric or comparison metric. The quantitative measure output by the dissimilarity metric can be called distance. If the two parameterized simulation models of a pair are similar, the distance can be small. In particular, if the two parameterized simulation models of a pair are identical (i.e., maximumly similar), the distance can be zero. However, if the two parameterized simulation models of a pair are not similar, the distance can be large.

As schematically illustrated, for example, in FIG. 1, the method 100 further comprises determining 140 the tolerance zone 30 in the ODD around the target parameter sample 10 based on the plurality of distances and on a maximum tolerable distance. In the exemplary embodiment in FIG. 3, step 140 is referred to as “calculating the tolerance zone.”

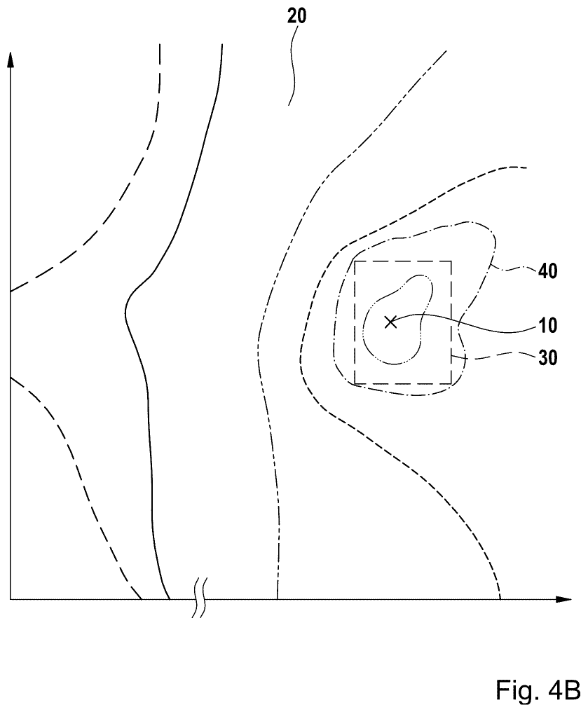

An exemplary result of determining the tolerance zone 30 around the target parameter sample 10 is shown in FIG. 4A-4B.

The target parameter sample 10 and the tolerance zone 30 can define a product sample to be produced for the product, hereinafter also referred to as the target product sample.

As schematically and optionally illustrated, for example, in FIG. 1, the method 100 can further comprise outputting 150 a requirement for the production of the product sample to be produced based on the target parameter sample 10 and the tolerance zone 30, wherein the requirement is met if (e.g., all) parameters of the product sample to be produced lie within the tolerance zone 30. In the exemplary embodiment in FIG. 3, step 150 is referred to as “converting the tolerance zone into individual parameter tolerances.”

Based on the requirement, the manufacturing department (e.g., prototype shop) can produce the product specimen. The requirement can comprise an algorithm or be such an algorithm with which it can be checked whether the one or more parameters of the product sample to be produced (i.e., the product specimen) lie within the tolerance zone 30 around the target parameter sample 10. Such an algorithm can be useful, for example, when the tolerance zone is higher-dimensional and deviates greatly from a product space (i.e., from a direct product of intervals).

The determination 140 of the tolerance zone 30 in the ODD can, for example, be carried out such that, in the tolerance zone 30, each distance to the parameterized simulation model associated with the target parameter sample 10 is less than the maximum tolerable distance. Alternatively, the determination 140 of the tolerance zone 30 in the ODD can also be carried out, for example, such that, in the tolerance zone 30, each distance to the parameterized simulation model associated with the target parameter sample 10 is less than or equal to the maximum tolerable distance. It is also possible, for example, that the determination 140 of the tolerance zone 30 in the ODD is carried out such that, in the tolerance zone 30, each distance to the parameterized simulation model associated with the target parameter sample 10 is at most approximately the maximum tolerable distance.

Furthermore, the determination 140 of the tolerance zone 30 in the ODD can be carried out such that the tolerance zone 30 is exactly or approximately maximum. For example, the tolerance zone 30 can be maximized based on the Lebesgue measure.

Furthermore, the determination 140 of the tolerance zone 30 in the ODD can be carried out such that the tolerance zone 30 is a contiguous set in the ODD. Alternatively or additionally, it can be carried out such that the tolerance zone 30 is a convex set in the ODD. In particular, the tolerance zone can be a convex, contiguous set in the ODD.

For example, the tolerance zone 30 can be a manifold, a polytope, in particular a convex polytope, a hyperellipsoid or a hypercube. A hypercube is particularly advantageous because the parameters and their tolerances are independent of each other. If this is not the case, the tolerance zone 30 can be defined as an (arbitrary) manifold. In order to reduce the memory requirements of such a manifold, it can be useful to approximate the manifold by a polytope or a hyperellipsoid.

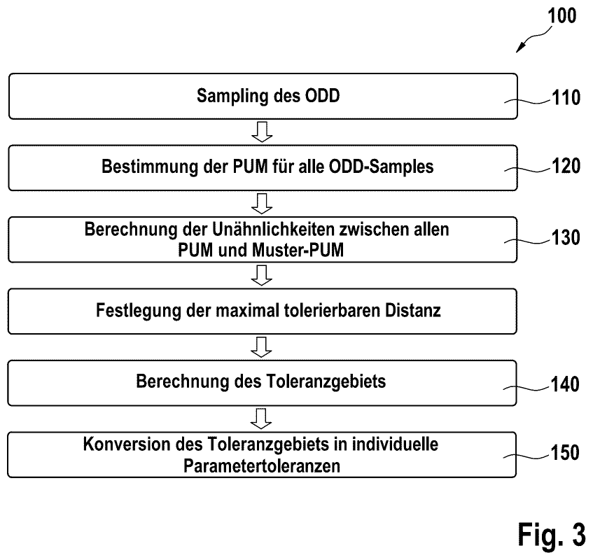

As schematically and optionally illustrated, for example, in FIG. 2A, the determination 140 of the tolerance zone 30 in the ODD can first comprise selecting 141 one or more parameterized simulation models of which the distance to the parameterized simulation model associated with the target parameter sample 10 sufficiently corresponds to the maximum tolerable distance, and then determining 142 the tolerance zone 30 based on the one or more selected 141 parameterized simulation models, optionally based on a polytope, in particular a convex polytope, a hyperellipsoid or a hypercube. For example, the distances can sufficiently correspond to the maximum tolerable distance if they each meet a predetermined criterion. For example, the distances can sufficiently correspond to the maximum tolerable distance if they deviate from the maximum tolerable distance by a maximum of 5%. The tolerance zone 30 can then be determined 142, for example, such that it comprises the parameter samples associated with the selected 141 parameterized simulation models. For example, these parameter samples can be the vertices of the polytope.

Alternatively, as schematically and optionally illustrated in FIG. 2B, the determination 140 of the tolerance zone 30 in the ODD can first comprise interpolating 143 the distances to the parameterized simulation model associated with the target parameter sample 10, resulting in a distance map in the ODD, and then determining 144 the tolerance zone 30 based on the distance map in the ODD, optionally based on a polytope, in particular a convex polytope, a hyperellipsoid or a hypercube. The interpolation 143 of the distances can be based on a fit function of which the fit parameters are ascertained, for example, by a Gaussian process. This can, but need not, be done recursively. A Gaussian process (GP) is a stochastic process and can in particular also be understood as a probability distribution over a function space and can thus be used to solve a regression problem. This makes it possible to represent the mapping of the ODD parameters to the distance (with respect to the dissimilarity metric) to the parameterized simulation model of the target product sample under consideration using a GP. For this purpose, the parameterizable GP is adapted based on a selection of parameter samples (e.g., in the “proximity” of the target parameter sample, e.g., in the representative zone of the target parameter sample or in the entire ODD) and the corresponding distances. Subsequently, for each point in the ODD, a normal distribution of the distance to the PUM of the considered target product sample can be calculated using the parameterized GP (cf. metric landscapes with uncertainties over the ODD in the vicinity of the target product sample). Based on the mean or a desired percentile (e.g., 95% percentile) of the probability distribution and the tolerated distance, the tolerance zone can finally be calculated (see second nearest isoline 40 around target parameter sample 10 in FIG. 4A-4B). The tolerance zone can be approximated, for example, by a polytope or ellipsoid of which the Lebesgue measure is maximized. The tolerance zone can, but need not, be a zone in the mathematical sense.

As schematically and optionally illustrated, for example in FIG. 1, the method 100 can further comprise first determining 110 a plurality of parameter samples 20 in the ODD for the product. A parameter sample in the ODD can comprise one or more parameters of the parameterizable simulation model. The determination 110 of the plurality of parameter samples 20 in the ODD can be carried out such that the ODD is covered sufficiently uniformly. Such sufficiently uniform coverage can be achieved, for example, based on pseudo-random numbers. Pseudo-random numbers (e.g., via the

Mersenne Twister) are usually uniformly distributed. Alternatively or additionally, such sufficiently uniform coverage can be based on Latin hypercube sampling. Alternatively or additionally, such sufficiently uniform coverage can be on a Sobol sequence. In particular, such sufficiently uniform coverage can be based on a combination of pseudo-random numbers, Latin hypercube sampling and/or a Sobol sequence. By assuming a sufficiently uniform coverage, representative parameterized simulation models of the parameterizable simulation model can be selected 140 better and more efficiently. Thus, for example, the determination 110 of the plurality of parameter samples 20 in the ODD can be based on pseudo-random numbers, on Latin hypercube sampling and/or on a Sobol sequence. Alternatively, the determination 110 of the plurality of parameter samples 20 in the ODD can be based only on a part of the ODD (e.g., only in an environment of the target parameter sample 10). In the exemplary embodiment in FIG. 3, step 110 is referred to as “sampling the ODD.”

Then, the method 100, as schematically and optionally illustrated, for example, in FIG. 1, can comprise forming 120 the parameterized simulation models based on the parameterizable simulation model and the plurality of parameter samples 20 in the ODD. For example, the parameterizable simulation model can be evaluated based on one of the parameter samples 20. Alternatively or additionally, a surrogate model for the parameterizable simulation model can be created here for each of the parameter samples 20.

The parameterizable simulation model can, but need not, be analytical. If the parameterizable simulation model is not analytical (e.g., in the case of a black box simulation model), it may not be possible to simply evaluate it based on one of the parameter samples. In such a case, for example, a surrogate model for the parameterizable simulation model can be created for each of the parameter samples using numerical simulation. Therefore, such a surrogate model can also be seen as a parameterized simulation model of the parameterizable simulation model. Therefore, the creation of the surrogate model for each of the parameter samples can represent a parameterization of the parameterizable simulation model. In this respect, the (parameterizable) simulation model itself can be parameterizable even if it is not in an analytical form.

In the exemplary embodiment in FIG. 3, step 120 is referred to as “determining the PUMs for all ODD samples,” where PAM denotes the parameterizable simulation model and PUM denotes the plurality of parameterized simulation models. Here, the “ODD samples” refer to the parameters of the respective parameterized simulation models of the plurality of parameterized simulation models.

The target parameter sample 10 can be one of a plurality of target parameter samples representative of the ODD.

The plurality of parameter samples 20 can lie within a representative range of the target parameter sample 10. The determination 110 of the plurality of parameter samples 20 in the representativeness range can be carried out in particular such that the representativeness range is covered sufficiently uniformly. Here too, the determination 110 of the plurality of parameter samples 20 can be based on pseudo-random numbers, on Latin hypercube sampling and/or on a Sobol sequence.

As schematically and optionally illustrated, for example, in FIG. 1, the method 100 can further comprise identifying 160 one or more parameters in the tolerance zone 30 that have a greater influence on the product. This can be done, for example, using a sensitivity analysis. This can improve the understanding of the product and its behavior. This can be particularly useful in the case of higher-dimensional ODDs, since the tolerance zone 30 can then no longer be directly inspected. This can improve the understanding of the system in the tolerance zone. The results can be taken into account when realizing the target product sample.

The method 100 can comprise determining 140 a tolerance zone in the ODD around a plurality of target parameter samples 10. In this case, a corresponding tolerance zone in the ODD can be determined around each target parameter sample.

The method 100 can comprise defining the maximum tolerable distance. In the exemplary embodiment in FIG. 3, the step is referred to as “defining the maximum tolerable distance.” In the case of the plurality of target parameter samples, this definition can be made globally, i.e., for all target parameters, or it can be defined individually for the target parameter samples of the plurality of target parameter samples.

As discussed above, the tolerance zone 30 can be used to ascertain one or more product samples of which the parameters lie within the tolerance zone around the target parameter sample. Alternatively or in addition to the above-discussed possibility of outputting 150 a requirement, the method 100 can comprise comparing parameter samples of real product specimens stored in a database with the tolerance zone, in particular based on a similarity relation. In case of the similarity being unsatisfactory, one or more instructions can be output on how to produce a sufficiently satisfactory product sample from a real product sample (e.g., by setup adjustments, shimming, etc.). This can, but need not, be a representative product sample.

The product specimen that the product sample to be produced realizes can be used to design a control system for the product. The design of the control system for the product can be based in particular on a large number of product specimens, each of which represents the product samples to be produced. In particular, if the product samples to be produced are representative of the ODD, the design and/or layout of a robust control system of the product can be improved. In particular, this allows the control system of the product to be designed to be particularly robust and reliable. This can in particular increase the safety of the product.

Furthermore, one or more product requirements can be tested on the basis of the product specimen that the product sample to be produced realizes. The testing of one or more product requirements can be based in particular on the plurality of product specimens that each product sample to be produced realizes. This allows the product to be designed to be robust and reliable. This can also increase the safety of the product in particular.

FIG. 3 shows an exemplary embodiment of the method 100. For example, the following steps can be carried out in sequence:
“sampling the ODD”, 110
“determining the PUMs for all ODD samples,” 120
“calculating the dissimilarities between all PUMs and sample PUMS,” 130
“defining the maximum tolerable distance”
“calculating the tolerance zone,” 140
“converting the tolerance zone into individual parameter tolerances,” 150

FIG. 4A illustrates an exemplary ODD with a plurality of parameterized simulation models (their parameter samples 20 are shown as points) and a target parameter sample 10 (shown as a cross) surrounded by a tolerance zone 30. In this example, the ODD is a two-dimensional product space, i.e., it is spanned by two parameters (one parameter in the x-direction, another parameter in the y-direction), each of which can take values in an interval. In general, the ODD does not have to be a product space, but can be an (arbitrary) manifold. The dimension of the ODD can be arbitrary. In this case, the tolerance zone 30 is an exemplary rectangle.

For this example, the distance (according to the dissimilarity metric) of each parameter sample 20 in the ODD (i.e., more precisely, its parameterized simulation model) to the parameterized simulation model associated with the target parameter sample 10 could be represented in 3D, i.e., in the z-direction orthogonal to the plane of the sheet. In 2D, four isolines (e.g., 40) are shown in the z-direction with respect to this quantity. The four solid lines each form an isoline, i.e., they have the same z-value. In addition to the isolines, a boundary of influence regions (dashed lines) of the respective representative parameterized simulation models is shown.

FIG. 4B illustrates the exemplary ODD from FIG. 4A without the plurality of parameterized simulation models (more precisely: their parameter samples 20).

In FIG. 4A-4B, for example to the left of the boundary of the influence regions (dashed lines), there could be a further target parameter sample around which a tolerance zone can also be determined according to method 100.

Furthermore, a computer system is disclosed that is designed to carry out the computer-implemented method 100 for ascertaining a tolerance zone 30 in an operational design domain (ODD) around a target parameter sample 10 of a parameterizable simulation model for a product. The computer system can comprise a processor and/or a working memory.

Furthermore, a computer program is disclosed that is designed to carry out the computer-implemented method 100 for ascertaining a tolerance zone 30 in an operational design domain (ODD) around a target parameter sample 10 of a parameterizable simulation model for a product. The computer program can be present, for example, in interpretable or in compiled form. For execution, it can (even in parts) be loaded into the RAM of a computer (e.g., of 10 the computer system), for example as a bit or byte sequence.

Also disclosed is a computer-readable medium or signal that stores and/or contains the computer program. The medium can comprise, for example, any one of RAM, ROM, EPROM, HDD, SSD, . . . , on/in which the signal is stored.

1-15. (canceled)

16. A computer-implemented method for ascertaining a tolerance zone in an operational design domain (ODD) around a target parameter sample of a parameterizable simulation model for a product, the product being a steer-by-wire steering system and/or a steering system for highly automated driving, comprising the following steps:
calculating a dissimilarity metric based on each pair of a plurality of pairs, wherein each pair includes a parameterized simulation model associated with the target parameter sample and a parameterized simulation model of a plurality of parameterized simulation models, wherein each pair yields a distance, thereby resulting in a plurality of distances; and
determining the tolerance zone in the ODD around the target parameter sample based on the plurality of distances and on a maximum tolerable distance.

17. The method according to claim 16, wherein the dissimilarity metric is based on a gap metric and/or a ν-gap metric and/or an L2 metric

18. The method according to claim 16, wherein the target parameter sample and the tolerance zone define a product sample to be produced for the product.

19. The method according to claim 18, further comprising:
outputting a requirement for the production of the product sample to be produced based on the target parameter sample and the tolerance zone, wherein the requirement is met when parameters of the product sample to be produced lie within the tolerance zone.

20. The method according to claim 19, wherein the requirement includes an algorithm that can be used to check whether the parameters of the product sample to be produced lie within the tolerance zone.

21. The method according to claim 16, wherein the determination of the tolerance zone in the ODD is carried out such that, in the tolerance zone, each distance to the parameterized simulation model associated with the target parameter sample is less than the maximum tolerable distance.

22. The method according to claim 21, wherein the determination of the tolerance zone in the ODD is carried out such that the tolerance zone is maximum.

23. The method according to claim 22, wherein the tolerance zone is maximized based on a Lebesgue measure.

24. The method according to claim 16, wherein the determination of the tolerance zone in the ODD includes:
selecting one or more parameterized simulation models of which a distance to the parameterized simulation model associated with the target parameter sample sufficiently corresponds to the maximum tolerable distance; and
determining the tolerance zone based on the one or more selected parameterized simulation models, based on a convex polytope or a hyperellipsoid or a hypercube.

25. The method according to claim 16, wherein the determination of the tolerance zone in the ODD includes:
interpolating distances to the parameterized simulation model associated with the target parameter sample, resulting in a distance map in the ODD;
determining the tolerance zone based on the distance map in the ODD.

26. The method according to claim 25, wherein the interpolation of the distances is based on a fit function of which fit parameters are ascertained by a Gaussian process.

27. The method according to claim 16, wherein the target parameter sample is one of a plurality of target parameter samples representative of the ODD.

28. The method according to claim 27, further comprising:
determining a plurality of parameter samples in the ODD for the product;
forming the parameterized simulation models based on the parameterizable simulation model and the plurality of parameter samples in the ODD, wherein: (i) the parameterizable simulation model is evaluated based on one of the parameter samples and/or (ii) a surrogate model for the parameterizable simulation model is created for one of the parameter samples.

29. The method according to claim 28 when dependent on claim 9, wherein the plurality of parameter samples lie within a representativeness range of the target parameter sample.

30. The method according to claim 16, further comprising:
identifying one or more parameters in the tolerance zone that have a greater influence on the product.

31. A computer system configured to carry out a computer-implemented method for ascertaining a tolerance zone in an operational design domain around a target parameter sample of a parameterizable simulation model for a product, the method comprising the following steps:
calculating a dissimilarity metric based on each pair of a plurality of pairs, wherein each pair includes a parameterized simulation model associated with the target parameter sample and a parameterized simulation model of a plurality of parameterized simulation models, wherein each pair yields a distance, thereby resulting in a plurality of distances; and
determining the tolerance zone in the ODD around the target parameter sample based on the plurality of distances and on a maximum tolerable distance.

32. A non-transitory computer-readable medium on which is stored a computer program for ascertaining a tolerance zone in an operational design domain (ODD) around a target parameter sample of a parameterizable simulation model for a product, the computer program, when executed by a computer, causing the computer to perform the following steps:
calculating a dissimilarity metric based on each pair of a plurality of pairs, wherein each pair includes a parameterized simulation model associated with the target parameter sample and a parameterized simulation model of a plurality of parameterized simulation models, wherein each pair yields a distance, thereby resulting in a plurality of distances; and
determining the tolerance zone in the ODD around the target parameter sample based on the plurality of distances and on a maximum tolerable distance.
